(19) United States
(12) Patent Application Publication
(10) Pub. No.: US 2011/0173444 A1
(43) Pub. Date: Jul. 14, 2011

(54) IMAGE FORMING APPARATUS, IMAGE FORMATION PROCESSING METHOD, AND COMPUTER-READABLE RECORDING MEDIUM HAVING STORED THEREON COMPUTER PROGRAMS FOR THE IMAGE FORMATION PROCESSING METHOD

(75) Inventors: Toshiyuki Sato, Shizuoka-ken (JP); Mutsumi Nochi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/004,086

(22) Filed: Jan. 11, 2011

Related U.S. Application Data
(60) Provisional application No. 61/294,151, filed on Jan. 12, 2010.

(51) Int. Cl. H04L 29/06; G06F 3/12

(52) U.S. Cl. 713/165; 358/1.15

(57) ABSTRACT

According to one embodiment, an image forming apparatus includes: an interface configured to communicate with an external storage device; a file acquiring unit configured to acquire a processing target file to be subjected to image formation processing from the external storage device via the interface; a user-information acquiring unit configured to acquire user information for identifying a user who instructs execution of the image formation processing on the processing target file; a determining unit configured to determine, if the processing target file is a file encrypted in a decryptable encryption system, whether user information for identifying a creator of the processing target file associated with the file and the user information acquired by the user-information acquiring unit coincide with each other; and a decrypting unit configured to decrypt the processing target file if the determining unit determines that the pieces of user information coincide with each other.

### CROSS-REFERENCE TO RELATED APPLICATION

This application is based upon and claims the benefit of priority from U.S. provisional application 61/294151, filed on Jan. 12, 2010; the entire contents of each of which are incorporated herein by reference.

### FIELD

Embodiments described herein relate generally to an image forming apparatus adapted to so-called direct printing for directly printing a file stored in an external storage device such as a removable medium.

### BACKGROUND

In the past, as an image forming apparatus such as a MFP (Multi Function Peripheral), there has been known an image forming apparatus capable of performing direct printing using a removable medium (an external storage device) such as a flash memory.

Usually, in order to perform printing with the image forming apparatus, it is necessary to create a print job using a printer driver corresponding to the image forming apparatus and transmit the created print job to the image forming apparatus.

The direct printing is processing for connecting the removable medium to the image forming apparatus and directly printing, in the image forming apparatus, a file recorded on the removable medium.

Therefore, the direct printing is convenient because image formation can be performed without the intervention of a computer. The image formation can be speedily performed because the image formation can be performed without starting the computer.

However, in the direct printing, if there is an image forming apparatus adapted to the direct printing, anybody can apply image formation processing to a sheet and view content of a file. For example, if an outsider who is not permitted to view confidential data illegally acquires a removable medium having the data recorded thereon, the outsider can subject a file of the data to the direct printing and view content of the file.

On the other hand, if an encrypted file is recorded on a removable medium using encryption processing software or the like, others cannot subject the encrypted file to the direct printing. However, this is inconvenient for a creator of the encrypted file because the creator himself or herself cannot perform the directing printing of the encrypted file either.

### DESCRIPTION OF THE DRAWINGS

FIG. 1 is a block diagram for explaining the configuration of a system including an image forming apparatus and an external storage device;

FIG. 2 is a functional block diagram for explaining functions of the image forming apparatus;

FIG. 3 is a system diagram of a system configuration of a computer that creates a file for direct printing;

FIG. 4 is a functional block diagram for explaining functions of the computer;

FIG. 5 is a flowchart for explaining a flow of processing of direct printing of an encrypted file stored in the external storage device in the image forming apparatus;

FIG. 6 is a functional block diagram for explaining functions of a computer that creates a file for direct printing;

FIG. 7 is a functional block diagram for explaining functions of an image forming apparatus;

FIG. 8 is a flowchart for explaining a flow of processing of direct printing of an encrypted file stored in an external storage device in the image forming apparatus;

FIG. 9 is a functional block diagram for explaining functions of a computer that creates a file for direct printing;

FIG. 10 is a functional block diagram for explaining functions of an image forming apparatus;

FIG. 11 is a diagram of data structure of a private key database; and

FIG. 12 is a flowchart for explaining a flow of processing of direct printing of an encrypted file stored in an external storage device in the image forming apparatus.

### DETAILED DESCRIPTION

In general, according to one embodiment, an image forming apparatus includes an interface, a file acquiring unit, a user-information acquiring unit, a determining unit, and a decrypting unit. The interface communicates with an external storage device. The file acquiring unit acquires a processing target file to be subjected to image formation processing from the external storage device via the interface. The user-information acquiring unit acquires user information for identifying a user who instructs execution of the image formation processing on the processing target file. The determining unit determines, if the processing target file is a file encrypted in a decryptable encryption system, whether user information for identifying a creator of the processing target file associated with the file and the user information acquired by the user-information acquiring unit coincide with each other. The decrypting unit decrypts the processing target file if the determining unit determines that the pieces of user information coincide with each other.

Embodiments are explained below with reference to the accompanying drawings.

### First Embodiment

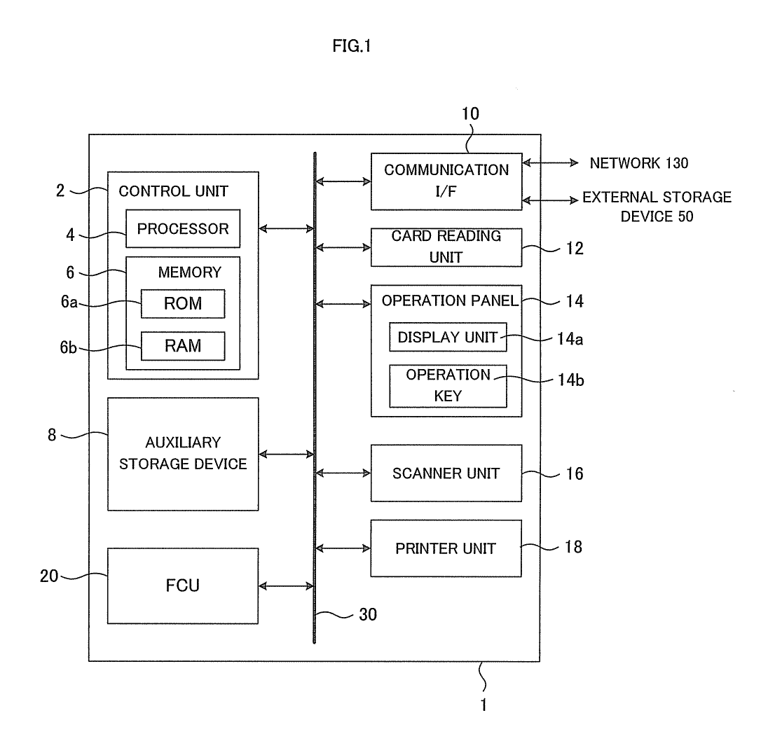

FIG. 1 is a block diagram for explaining the configuration of a system including an image forming apparatus 1 and an external storage device 50.

The image forming apparatus 1 includes a control unit 2, an auxiliary storage device 8, a communication interface (I/F) 10, a card reading unit 12, an operation panel 14, a scanner unit 16 configured to read an original document, a printer unit 18 configured to form an image, and a facsimile control unit (FCU) 20. The components of the image forming apparatus 1 are connected via a bus 30. The external storage device 50 connected to the communication I/F 10 is a storage device such as a USE memory (a USB flash drive) connected to the image forming apparatus 1 in order to perform so-called direct printing. In this embodiment, the external storage device 50 stores encrypted data that is decrypted by decryption processing explained later and subjected to direct printing processing.

In this specification, “direct printing” means processing in which the image forming apparatus 1 directly prints, without the intervention of a printer driver executed in a computer or the like, data stored in an external storage device.

A system configuration of the image forming apparatus 1 is explained below.

The control unit 2 functions according to a processor 4, a memory 6, and an operating system (OS).

The processor 4 is a CPU (Central Processing Unit) or a MPU (Micro Processor Unit).

The memory 6 is, for example, a semiconductor memory. The memory 6 includes a ROM (Read Only Memory) 6a having stored therein a control program of the processor 4 and a RAM (Random Access Memory) 6b configured to provide the processor 4 with a temporary work area.

The control unit 2 controls the communication I/F 10, the card reading unit 12, the operation panel 14, the scanner unit 16, the printer unit 18, the FCU 20, and the like on the basis of control programs or the like stored in the ROM 6a or the auxiliary storage device 8. The control unit 2 may further have various image processing functions. The control unit 2 may include an ASIC (Application Specific Integrated Circuit) configured to realize a part or all of functions of the image forming apparatus 1.

The auxiliary storage device 8 stores application programs and an OS. The application programs include computer programs for executing functions of the image forming apparatus 1 such as a copy function, a print function, a scanner function, a facsimile function, and a network file function. The application programs further include an application for Web clients (a Web browser) and other applications.

The auxiliary storage device 8 stores, for example, image data generated by reading an original document with the scanner unit 16, data acquired from the external storage device 50 via the communication I/F 10, and data acquired from other apparatuses on the outside connected via a network 130.

The auxiliary storage device 8 may be, for example, a magnetic storage device such as a hard disk drive, an optical recording device, a semiconductor storage device (a flash memory, etc.), or an arbitrary combination of these storage devices. The auxiliary storage device 8 appropriately stores software update, a protected electronic document, text data, account information, policy information, and the like.

The communication I/F 10 is an interface connected to the external storage device 50. The communication I/F 10 is also an interface connected to apparatuses on the outside via the network 130. The communication I/F 10 is connected to external apparatuses via the network 130 by appropriate wireless communication or wired communication conforming to IEEE802.15, IEEE802.11, IEEE802.3, IEEE1284, or the like such as Bluetooth (registered trademark), infrared connection, or optical connection. The communication I/F 10 includes a buffer and temporarily stores a part or all of data received via the network 130 in the buffer.

The control unit 2 communicates with the external storage device 50 via the communication I/F 10 and communicates with other external apparatuses such as a PC (Personal Computer) connected via the network 130.

The card reading unit 12 reads an ID card in order to perform login processing when a user uses the image forming apparatus 1. The control unit 2 shifts to a login state and permits use of the image forming apparatus 1 by the user if user information read by the card reading unit 12 is information registered in the auxiliary storage device 8 or the like.

The operation panel 14 includes a display unit 14a of a touch panel type and various operation keys 14b. The display unit 14a displays instruction items concerning printing conditions such as a sheet size, the number of copies, printing density setting, and finishing (stapling or folding). The operation keys 14b include a ten key, a reset key, a stop key, and a start key. The user can input, from the display unit 14a or the operation keys 14b, instructions for various kinds of processing or the items displayed on the display unit 14a and instruct the various kinds of processing or the items.

The scanner unit 16 includes an incorporated scanning and reading unit configured to read an original document as an image, a document placing table, and an auto document feeder configured to convey the original document to a reading position. The scanning and reading unit of the scanner unit 16 reads an original document set on the document placing table or the auto document feeder.

The printer unit 18 forms, on a sheet, an image corresponding to image data of an original document read by the scanner unit 16 or an image corresponding to data transmitted from an external PC via the network 130. The printer unit 18 can also form an image of data stored in the external storage device 50 connected to the communication I/F 10 using a direct printing function.

The facsimile control unit (FCU) 20 controls transmission processing and reception processing for a facsimile in the image forming apparatus 1.

The external storage device 50 is a storage device on the outside connected via the communication I/F 10. As the external storage device 50, for example, a flash memory such as a USB memory or a memory card or a magnetic storage device such as a hard disk drive can be used. When the external storage device 50 is the USB memory, the image forming apparatus 1 is connected to the external storage device 50 via a USB (Universal Serial Bus). However, the external storage device 50 is not limited to a device directly connected to the communication I/F 10. The external storage device 50 only has to be a device connected for the direct printing not via a printer driver and may be a storage device connected by wireless communication.

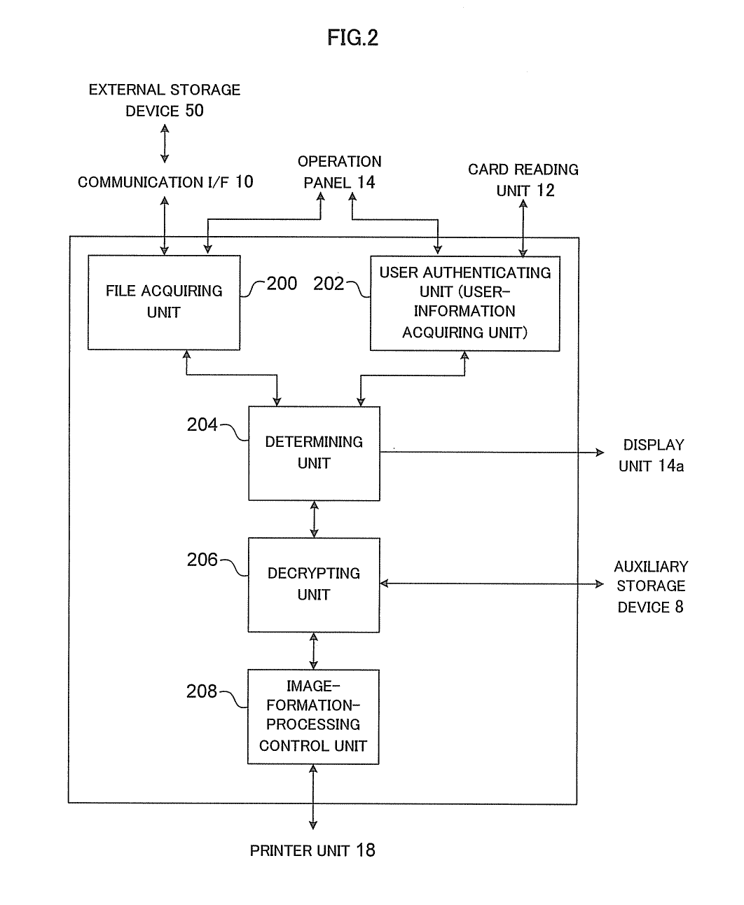

Functional blocks of the image forming apparatus 1 are explained below. FIG. 2 is a functional block diagram of functions of the image forming apparatus 1 that decrypts encrypted data stored in the external storage device 50 and performs the direct printing.

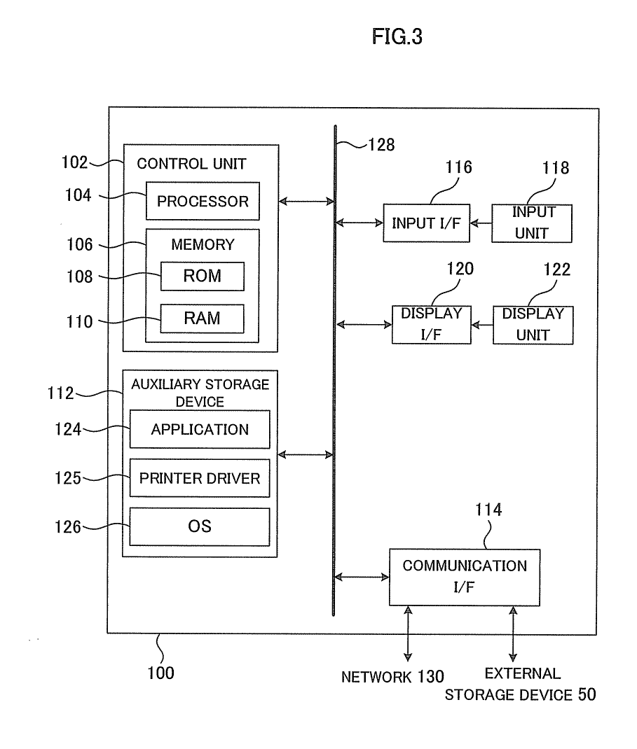

Processing for creating an encrypted file to be subjected to the direct printing in the image forming apparatus 1 and storing the encrypted file in the external storage device 50 and a computer 100 that performs the processing are explained below. FIG. 3 is a system diagram of a system configuration of the computer 100. The computer 100 includes software, hardware, or an appropriate combination of the software and the hardware for executing, for example, processing for creating an encrypted file for the direct printing.

The computer 100 includes a control unit 102, an auxiliary storage device 112, a communication interface (communication I/F) 114, an input interface (input I/F) 116, an input unit 118, a display interface (display I/F) 120, and a display unit 122. As the computer 100 that generates an encrypted file, a PC (Personal Computer) may be used.

The control unit 102 functions according to a processor 104 including a CPU (Central Processing Unit) or a MPU (Micro Processing Unit), a memory 106, and an operating system (OS) 126.

The processor 104 executes a printer driver 125 stored by the auxiliary storage device 112, performs encryption processing for data as a target of the direct printing to generate an encrypted file using a function of the printer driver 125, and causes the external storage device 50 to store the generated file via the communication I/F 114.

The memory 106 is, for example, a semiconductor memory. The memory 106 includes a ROM (Read Only Memory) 108 configured to store a control program of the processor 104 and a RAM (Random Access Memory) 110 configured to provide the processor 104 with a temporary work area. The components of the computer 100 are connected via a bus 128.

The auxiliary storage device 112 stores an application program 124, the printer driver 125, and the OS 126, which is the control program of the processor 104. The application program 124 operates as software of the OS 126. The application program 124 includes a Web application in addition to general software such as document creation software.

The printer driver 125 is a device driver configured to control the image forming apparatus 1 according to a printing instruction from the application program 124. The printer driver 125 operates as software of the OS 126. In this embodiment, the printer driver 125 controls encryption processing for a file for the direct printing as explained above.

The auxiliary storage device 112 having the functions explained above may be, for example, a magnetic storage device such as a hard disk drive, an optical storage device, a semiconductor storage device such as a flash memory, or an arbitrary combination of the storage devices.

The communication I/F 114 is an interface connected to apparatuses on the outside. The communication I/F 114 communicates with the apparatuses on the outside (e.g., other PCs and the image forming apparatus 1) via the network 130 by appropriate wireless communication or wired communication conforming to IEEE802.15, IEEE802.11, IEEE802.3, IEEE1284, or the like such as Bluetooth (registered trademark), infrared connection, or optical connection. The control unit 102 communicates with the image forming apparatus 1, a USB device, and other external apparatuses via the communication I/F 114. In this embodiment, the communication I/F 114 communicates with the external storage device 50 configured to store an encrypted file for the direct printing.

The input I/F 116 is connected to the input unit 118. As the input unit 118, a keyboard device or a pointing device such as a mouse is used.

The display I/F 120 is connected to the display unit 122. The display I/F 120 receives data to be displayed on the display unit 122 from another component connected to the bus 128. The display I/F 120 outputs the display data to the display unit 122. As the display unit 122, for example, a display connected to a PC is used.

Processing for creating an encrypted file for the direct printing in the computer 100 is explained below. In the following explanation of this embodiment, it is assumed that a file to be encrypted for the direct printing is a PDL file obtained by converting a page as a printing target of an application executed in the computer 100 into a file of a page-description language (PDL) format.

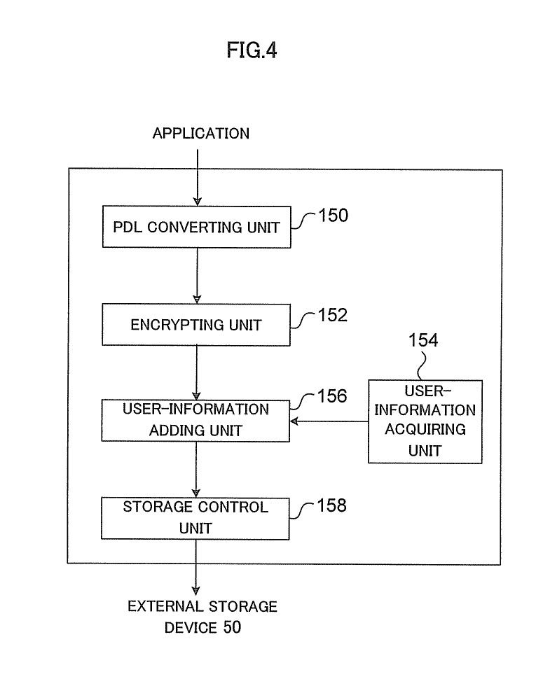

FIG. 4 is a functional block diagram for explaining the processing for creating an encrypted file in the computer 100.

The computer 100 includes a PDL converting unit 150, an encrypting unit 152, a user-information acquiring unit 154, a user-information adding unit 156, and a storage control unit 158.

When an instruction for executing processing for creating a file for the direct printing and storing the file in the external storage device 50 is received in the printer driver 125 started in an application executed in the computer 100, the PDL converting unit 150 converts a page as a printing target into a file of the PDL format.

The encrypting unit 152 encrypts the PDL file generated by the PDL converting unit 150. In the following explanation of this embodiment, it is assumed that the encrypting unit 152 encrypts the PDL file in a so-called common key encryption system in which a key same as a key used in decrypting the encrypted file is used.

The user-information acquiring unit 154 acquires user information with which a creator of the PDL file to be encrypted can be identified. The user-information acquiring unit 154 acquires, for example, user information for identifying a user who uses the application, which is a conversion source of the PDL file. Specifically, the computer 100 is set to perform login processing when the use of the application is started. The user-information acquiring unit 154 only has to acquire user information of a logged-in user.

The user-information adding unit 156 adds the user information acquired by the user-information acquiring unit 154 to the file encrypted by the encrypting unit 152.

The storage control unit 158 controls processing for causing the external storage device 50 to store the encrypted file added with the user information.

With the functions explained above, it is possible to create the encrypted file for the direct printing added with the user information and store the encrypted file in the external storage device 50.

Functional blocks of the image forming apparatus 1 for decrypting, in order to subject the encrypted file stored in the external storage device 50 by the functions explained above to the direct printing, the encrypted file and performing image formation processing are explained below.

As shown in FIG. 2, the image forming apparatus 1 includes a file acquiring unit 200, a user authenticating unit 202 as a user-information acquiring unit, a determining unit 204, a decrypting unit 206, and an image-formation-processing control unit 208. In the following explanation, it is assumed that a file to be subjected to the direct printing is the encrypted file added with the user information generated by the functions of the computer 100.

When the external storage device 50 is connected to the image forming apparatus 1 via the communication I/F 10, the direct printing is designated and a file to be subjected to the direct printing is designated by operation input by a user on the operation panel 14, the file acquiring unit 200 acquires the designated file.

The user authenticating unit 202 performs login processing for permitting the start of use of the image forming apparatus 1. Specifically, for example, the user authenticating unit 202 reads, with the card reading unit 12, an ID card carried by each user and acquires user information for identifying the user. The login processing by the user authenticating unit 202 is not limited to the reading of the ID card. The login processing may be performed according to input of an ID, a password, and the like for identifying the user to the operation panel 14.

The determining unit 204 compares user information added to the encrypted file acquired by the file acquiring unit 200 and the user information of the user logged in according to the login processing by the user authenticating unit 202 and determines the pieces of user information coincide with each other. If the pieces of user information do not coincide with each other, the determining unit 204 can display, with the operation panel 14, to the effect that decryption of the encrypted file is not permitted and the encrypted file cannot be decrypted.

If the determining unit 204 determines that the pieces of user information coincide with each other, the decrypting unit 206 decrypts the encrypted file using a key (a common key) same as a key used for encryption. The common key is stored in the auxiliary storage device 8 or the like in advance.

The image-formation-processing control unit 208 executes image formation processing with the printer unit 18 using a decrypted PDL file.

The functional blocks of the image forming apparatus 1 according to this embodiment are explained above.

With the configuration of the image forming apparatus 1 according to this embodiment, it is possible to determine whether user information acquired by the login processing for using the image forming apparatus 1 and user information added to an encrypted processing target file to be subjected to the direct printing processing coincide with each other and decrypt the file only if the pieces of user information coincide with each other. Therefore, if a creator of the file to be subjected to the direct printing and a user who attempts to perform the direct printing in the image forming apparatus 1 do not coincide with each other, it is possible not to perform the image formation processing.

For example, when a creator of an encrypted file is a user A, even if a user B attempts to illegally acquire the encrypted file and subject the encrypted file to the direct printing in the image forming apparatus 1, since user information of the logged-in user B and user information of the file do not coincide with each other, the user B cannot decrypt the encrypted file and cannot perform the image formation processing. Therefore, it is possible to prevent information leakage from the file created for the direct printing.

Even if the user B attempts the direct printing with an image forming apparatus not adapted to the login processing and decryption processing, since the target file is encrypted, the user B cannot perform image formation.

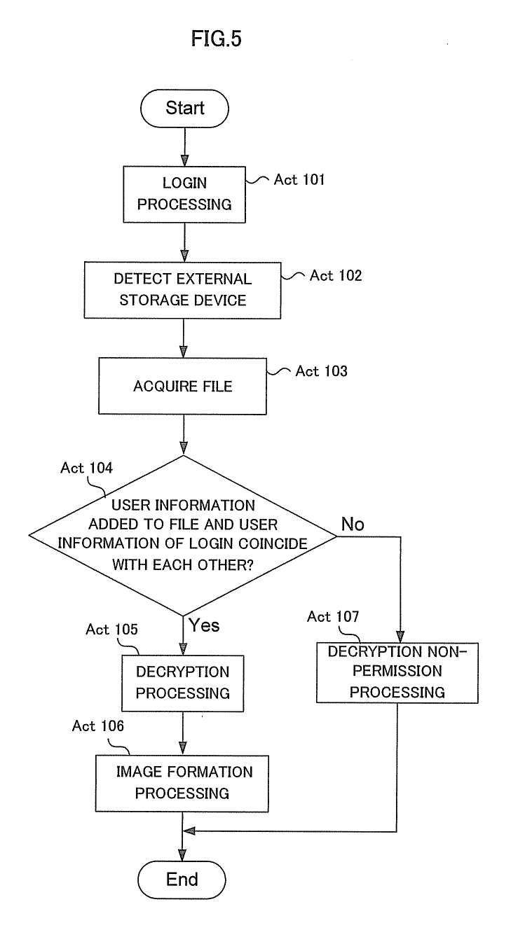

A flow of processing of the direct printing according to this embodiment is explained below. FIG. 5 is a flowchart for explaining a flow of processing of the direct printing of an encrypted file stored in the external storage device 50 in the image forming apparatus 1.

First, the card reading unit 12 reads an ID card of a user and the user authenticating unit 202 performs the login processing using read user information (Act 101). If the login processing is successful, the use of the image forming apparatus 1 is started.

Subsequently, when the user connects, for the direct printing, the external storage device 50 to the communication I/F 10 of the image forming apparatus 1, the control unit 2 detects the connected external storage device 50 (Act 102).

The file acquiring unit 200 acquires, out of files stored in the detected external storage device 50, an encrypted file designated as a target file of the direct printing by operation input by the user on the operation panel 14 (Act 103). The acquisition of the target file of the direct printing is not limited to the selection by the operation of the operation panel 14 by the user. An encrypted file stored in the external storage device 50 may be automatically acquired according to setting. Decryption processing after the acquisition only has to be performed for the encrypted file.

The determining unit 204 compares user information added to the file acquired by the file acquiring unit 200 and the user information of the user logged in through the login processing and determines whether the pieces of user information coincide with each other (Act 104).

If the pieces of user information coincide with each other (Yes in Act 104), the decrypting unit 206 acquires a key, which is stored in advance, same as a key used in encryption of the encrypted file from the auxiliary storage device 8 or the like and the decrypting unit 206 decrypts the encrypted file acquired by the file acquiring unit 200 using the key (Act 105).

The image-formation-processing control unit 208 performs the image formation processing with the printer unit 18 using a decrypted PDL file (Act 106).

On the other hand, if the determining unit 204 determines that the user information added to the file acquired by the file acquiring unit 200 and the user information of the user logged in through the login processing do not coincide with each other (No in Act 104), the determining unit 204 performs non-permission processing for not permitting decryption (Act 107). Specifically, the determining unit 204 does not cause the decrypting unit 206 to execute the decryption processing of the file. Further, the determining unit 204 may perform processing for causing the display unit 14a of the operation panel 14 to display to the effect that the pieces of user information do not coincide with each other and the decryption processing is not permitted.

The flow of the processing of the direct printing by the image forming apparatus 1 according to this embodiment is explained above.

The login processing in Act 101 does not need to be performed in Act 101 for the first time. The login processing only has to be performed before the processing for determining coincidence or non-coincidence of the pieces of user information in Act 104.

In the above explanation of this embodiment, if the user information of the user logged in to start the use of the image forming apparatus 1 and the user information added to the file to be subjected to the direct printing do not coincide with each other, the file is not decrypted. However, the present invention is not limited to this. For example, the decryption of the file may be permitted if the logged-in user has a higher-order authority, for example, the logged-in user is an administrator, Specifically, for example, if the user information added to the file indicates the user A but the logged-in user is the administrator, the pieces of user information do not coincide with each other. However, even in this case, if the logged-in administrator is permitted to perform the decryption processing, the determining unit 204 can cause the decrypting unit 206 to execute the decryption of the file.

In the above explanation of this embodiment, the determining unit 204 performs the login processing for using the image forming apparatus 1 in the user authenticating unit 202 and uses the user information of the logged-in user. However, the present invention is not limited to this. For example, if a target file of the direct printing is an encrypted file, the determining unit 204 may acquire user information according to, for example, reading of a card or input of an ID and a password in order to use the user information for determination concerning whether the decryption processing is permitted.

### Second Embodiment

A second embodiment is explained below. In this embodiment, falsification of user information added to a file to be subjected to direct printing is prevented to further improve security by using a digital signature. Components same as those in the first embodiment are denoted by the same reference numerals and signs and explanation of the components is omitted.

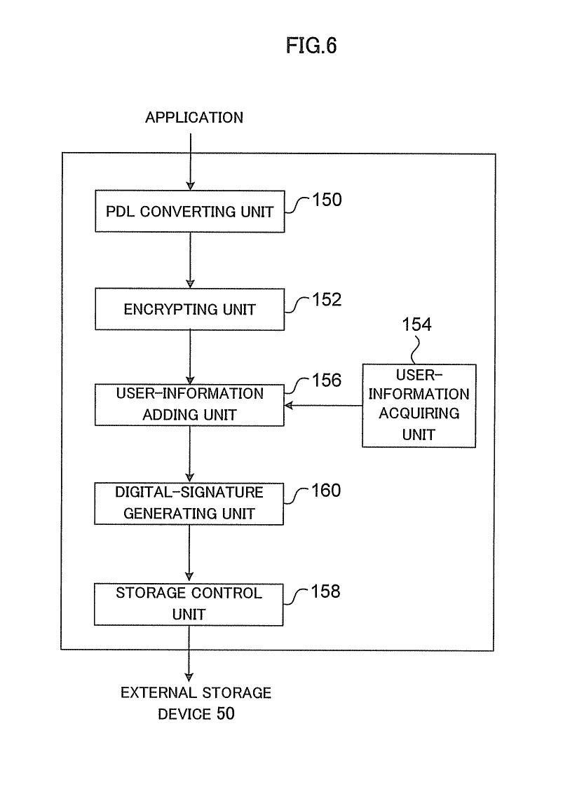

First, processing for creating an encrypted file added with a digital signature to be subjected to the direct printing is explained. FIG. 6 is a functional block diagram for explaining functions of the computer 100. As in the first embodiment, the computer 100 includes the PDL converting unit 150, the encrypting unit 152, the user-information acquiring unit 154, the user-information adding unit 156, and the storage control unit 158. The computer 100 further includes a digital-signature generating unit 160.

The PDL converting unit 150, the encrypting unit 152, the user-information acquiring unit 154, the user-information adding unit 156, and the storage control unit 158 perform processing same as the processing in the first embodiment.

The digital-signature generating unit 160 generates a digital signature and adds the digital signature to a PDL file encrypted by the encrypting unit 152 and added with user information by the user-information adding unit 156. Specifically, the digital-signature generating unit 160 generates a hash value of user information added to an encrypted file and generates a digital signature using the hash value. The digital signature can be generated by a generation processing method for a digital signature generally in use.

The hash value is a fixed-length random number generated by irreversible conversion performed by using a hash function, which is an irreversible function in one direction. The hash function has a characteristic that the same hash value is always generated from the same data, the hash value changes when content of input data changes even a little, and it is impossible to derive the original data from the changed hash value.

The file added with the digital signature by the digital-signature generating unit 160 is stored in the external storage device 50 by the storage control unit 158.

In this way, the digital-signature generating unit 160 generates the digital signature using the hash value of the user information and adds the digital signature to the file. This makes it possible to detect presence or absence of falsification of the user information when the direct printing is performed in the image forming apparatus 1. Direct print processing for the encrypted file added with the digital signature in the image forming apparatus 1 is explained below.

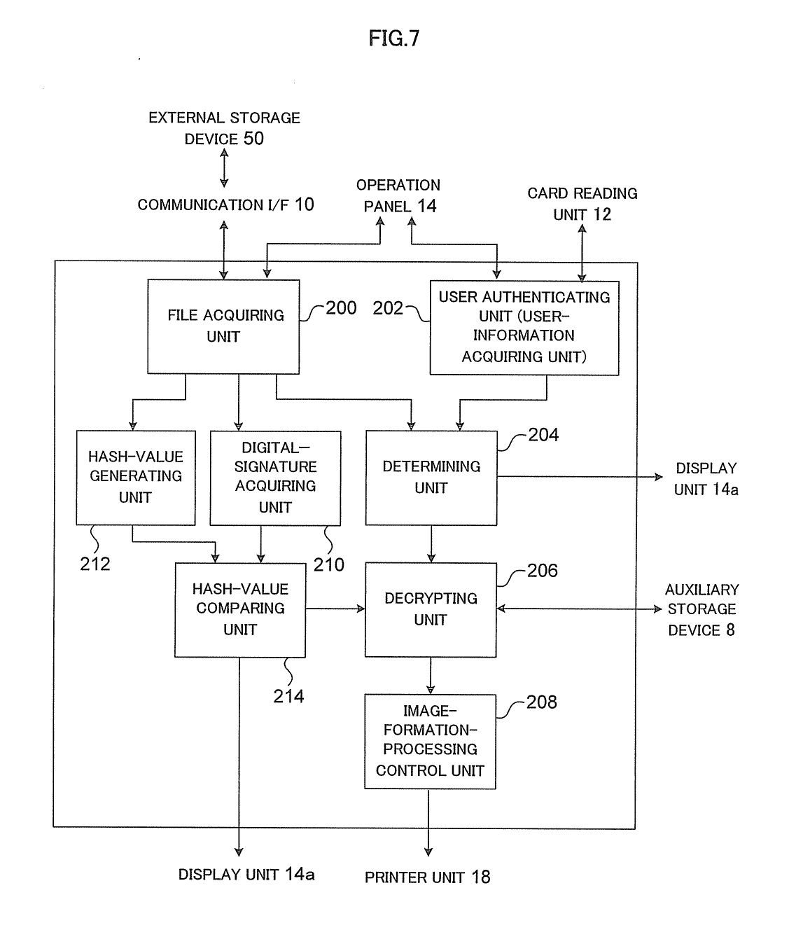

FIG. 7 is a functional block diagram for explaining functions of the image forming apparatus 1 according to this embodiment. The image forming apparatus 1 according to this embodiment further includes, in addition to functional blocks same as those in the first embodiment, a digital-signature acquiring unit 210, a hash-value generating unit 212 as an irreversible-conversion-value generating unit, and a hash-value comparing unit 214 as an irreversible-conversion-value comparing unit.

The digital-signature acquiring unit 210 acquires a digital signature added to an encrypted file acquired by the file acquiring unit 200 from the external storage device 50 in order to perform the direct printing. The digital-signature acquiring unit 210 extracts a hash value of user information included in the digital signature. Usually, when the digital signature is generated, the hash value of the digital signature is encrypted by a private key of a user who crates the digital signature. Therefore, the digital-signature acquiring unit 210 extracts the hash value from the digital signature by decrypting the encrypted hash value using a public key corresponding to the private key used for the encryption. The public key for decrypting the encrypted hash value of the digital signature only has to be stored in the auxiliary storage device 8 or the like in advance.

The hash-value generating unit 212 generates a hash value of the present user information added to an encrypted file acquired by the file acquiring unit 200 from the external storage device 50 in order to perform the direct printing.

The hash-value comparing unit 214 compares the hash value extracted by the digital-signature acquiring unit 210 from the digital signature added to the file and the hash value of the present user information generated by the hash-value generating unit 212 and determines whether the hash values coincide with each other. If the hash values coincide with each other, it is possible to regard that the user information added when the file is created and the user information added to the present file coincide with each other. On the other hand, if the hash values do not coincide with each other, it is possible to discriminate that the user information added when the file is created and the user information added to the present file do not coincide with each other and the user information is falsified after the creation of the file.

If the determining unit 204 determines that the user information added to the file and the user information of the logged-in user coincide with each other and the hash-value comparing unit 214 determines that the compared hash values coincide with each other, the decrypting unit 206 decrypts the encrypted processing target file to be subjected to the direct printing.

The functional blocks of the image forming apparatus 1 according to this embodiment are explained above.

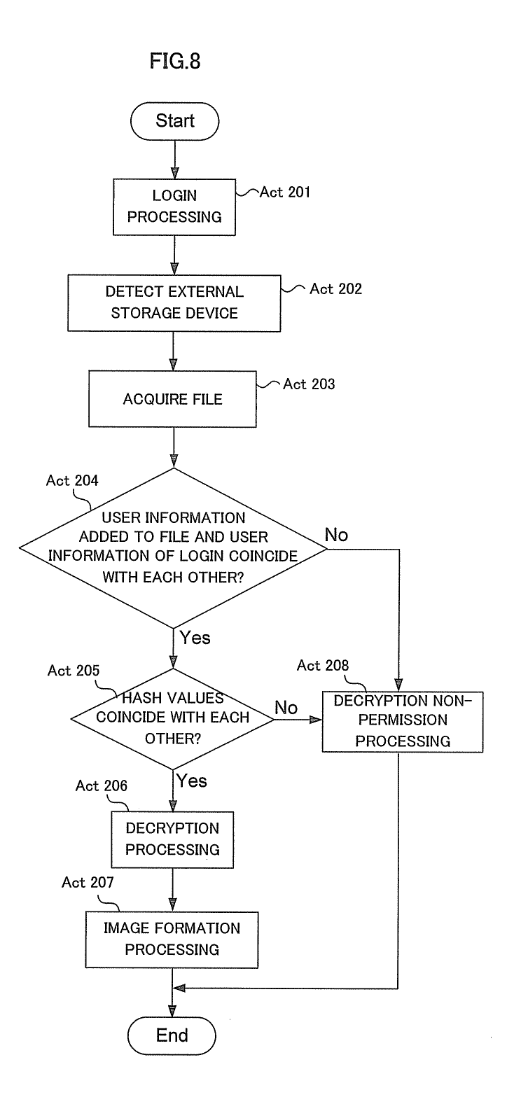

A flow of processing of the direct printing according to this embodiment is explained below. FIG. 8 is a flowchart for explaining a flow of processing of the direct printing of an encrypted file stored in the external storage device 50 in the image forming apparatus 1.

First, the card reading unit 12 reads an ID card of a user and the user authenticating unit 202 performs login processing using read user information (Act 201). When the login processing is successful, the use of the image forming apparatus 1 is started.

Subsequently, when the external storage device 50 is connected to the image forming apparatus 1, the control unit 2 detects the external storage device 50 connected to the communication I/F 10 (Act 202).

The file acquiring unit 200 acquires, out of files stored in the detected external storage device 50, an encrypted file designated as a target file of the direct printing by operation input by the user on the operation panel 14 (Act 203).

The determining unit 204 compares user information added to the file acquired by the file acquiring unit 200 and the user information of the user logged in through the login processing and determines whether the pieces of user information coincide with each other (Act 204).

If the pieces of user information coincide with each other (Yes in Act 204), the hash-value comparing unit 214 compares a hash value of user information extracted by the digital-signature acquiring unit 210 from a digital signature added to the file and a hash value of the user information generated by the hash-value generating unit 212 from the user information added to the present file and determines whether the hash values coincide with each other (Act 205).

On the other hand, if the determining unit 204 determines that the pieces of user information do not coincide with each other (No in Act 204), the determining unit 204 performs non-permission processing for not permitting decryption (Act 208). The non-permission processing is the same as that in the first embodiment.

If the hash-value comparing unit 214 determines in Act 205 that the hash values coincide with each other (Yes in Act 205), the decrypting unit 206 acquires a key, which is stored in advance, same as a key used in encryption of the encrypted file from the auxiliary storage device 8 or the like and the decrypting unit 206 decrypts the encrypted file using the key (Act 206).

The image-formation-processing control unit 208 performs image formation processing with the printer unit 18 using a decrypted PDL file (Act 207).

On the other hand, if the hash-value comparing unit 214 determines that the hash values do not coincide with each other (No in Act 205), the hash-value comparing unit 214 considers that the user information is falsified and performs non-permission processing for not permitting decryption of the encrypted file (Act 208). The non-permission processing only has to be processing same as the processing executed by the determining unit 204. In other words, the hash-value comparing unit 214 may perform processing for not causing the decrypting unit 206 to execute decryption and for causing the display unit 14a to display to the effect that decryption processing is not permitted.

The flow of the processing of the direct printing by the image forming apparatus 1 according to this embodiment is explained above.

With the image forming apparatus 1 according to this embodiment, when a file to be subjected to the direct printing is created, a digital signature created on the basis of user information added to the file is further added to the file. This makes it possible to determine whether the present user information added to an encrypted file and user information at the time of creation of the encrypted file coincide with each other and check whether the user information is not falsified. If the pieces of user information do not coincide with each other, i.e., if the user information is falsified, decryption of the encrypted file is prohibited. This makes it possible to prevent an outsider, who is not originally permitted to perform the decryption processing, from impersonating a user permitted to perform the decryption processing to decrypt and print the file.

On the other hand, if the digital signature is not added, for example, when the user B falsifies user information of an encrypted file created by the user A into user information of the user B, the user information of the logged-in user B and the falsified user information coincide with each other if the user B can log in to the image forming apparatus 1. Therefore, the user B, who is not originally permitted to decrypt the encrypted file, can decrypt and print the encrypted file.

In the above explanation of this embodiment, the hash value included in the digital signature is created by using the user information added to the file. However, the present invention is not limited to this. A hash value may be generated from an entire file including user information added to an encrypted file and the encrypted file. In this case, the hash-value generating unit 212 also generates a hash value from the encrypted file and the user information added to the encrypted file.

### Third Embodiment

A third embodiment is explained below. In this embodiment, direct printing by an outsider who illegally acquires a file is more surely prevented by using a public key encryption system. Components same as those in the first embodiment are denoted by the same reference numerals and signs and explanation of the components is omitted.

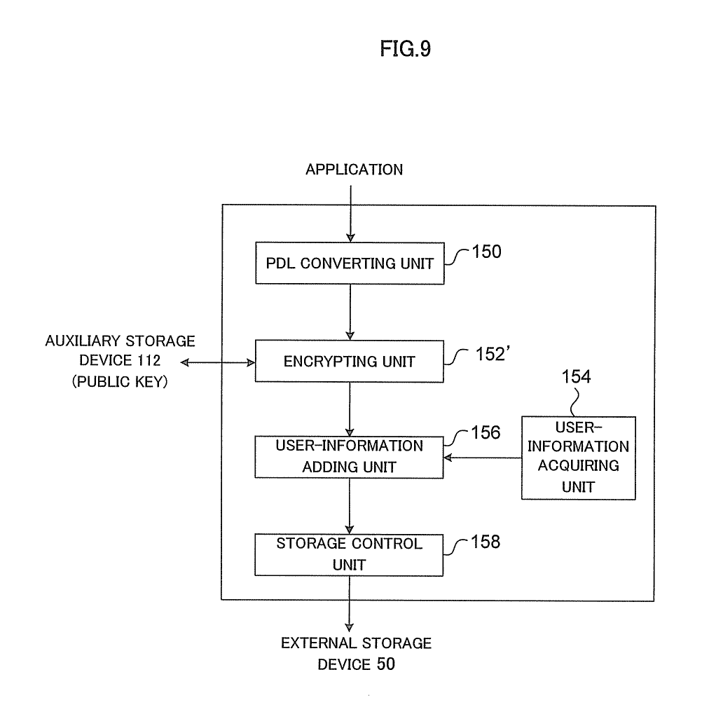

First, processing for creating an encrypted file to be subjected to the direct printing using public key encryption is explained. FIG. 9 is a functional block diagram for explaining functions of the computer 100. As in the first embodiment, the computer 100 includes the PDL converting unit 150, the user-information acquiring unit 154, the user-information adding unit 156, and the storage control unit 158. In this embodiment, the computer 100 further includes an encrypting unit 152′ configured to perform encryption in the public key encryption system.

As in the first embodiment, when the PDL converting unit 150 receives an instruction for executing processing for creating a file for the direct printing and storing the file in the external storage device 50 in the printer driver started in an application executed in the computer 100, the PDL converting unit 150 converts a page to be printed into a file of a PDL format.

The encrypting unit 152′ encrypts the file generated by the PDL converting unit 150 using a public key allocated to each user in advance and used for encryption of a file. Specifically, first, the user-information acquiring unit 154 acquires user information for identifying a user who uses the application, which is a conversion source of the PDL file. The encrypting unit 152′ acquires a public key associated with the user information from the auxiliary storage device 112 or the like in which the public key is stored in advance. The encrypting unit 152′ encrypts the file using the public key.

The public key is not limited to the public key acquired by the encrypting unit 152′ on the basis of the user information. It is also possible that a user performs operation for designating a public key of the user and the encrypting unit 152′ encrypts the file using the designated public key. However, the user identified by the user information added to the encrypted file and the user associated with the public key used for the encryption need to coincide with each other. If the users do not coincide with each other, when the encrypted file is decrypted in the image forming apparatus 1 as explained later, it is impossible to decrypt the encrypted file using a proper private key corresponding to an encrypted public key.

Functions of the user-information adding unit 156 and the storage control unit 158 are the same as those in the first embodiment. Therefore, explanation of the functions is omitted.

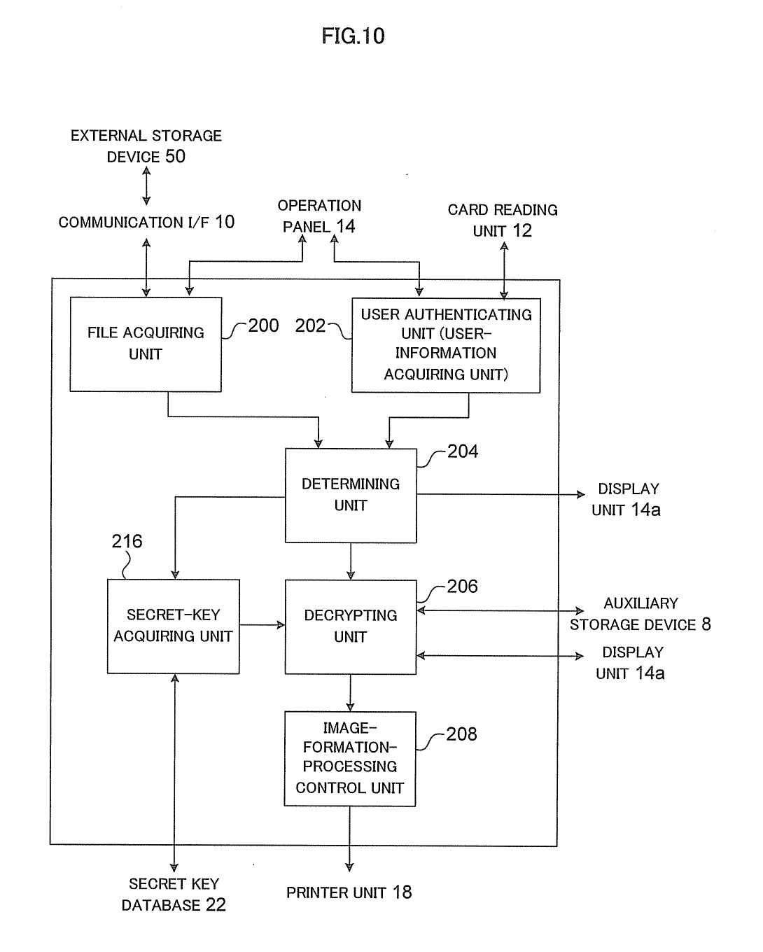

Functions of the image forming apparatus 1 for decrypting the file encrypted by using the public key as explained above and subjecting the file to the direct printing are explained below. FIG. 10 is a functional block diagram for explaining the functions of the image forming apparatus 1 according to this embodiment. The image forming apparatus 1 according to this embodiment further includes a private key acquiring unit 216 in addition to functional blocks same as those in the first embodiment.

The private key acquiring unit 216 acquires a private key, which corresponds to an encrypted public key, used for decrypting a file encrypted by using the public key. Specifically, the determining unit 204 determines whether user information acquired by the user authenticating unit 202 through user login processing to the image forming apparatus 1 and user information added to a file acquired by the file acquiring unit 200 coincide with each other. If the pieces of user information coincide with each other, the private key acquiring unit 216 acquires a private key associated with the coinciding user information. The private key is stored in advance in a private key database 22 in which private keys and user information are associated with each other. The private key database 22 is stored in a storage area in the image forming apparatus 1 such as the auxiliary storage device 8.

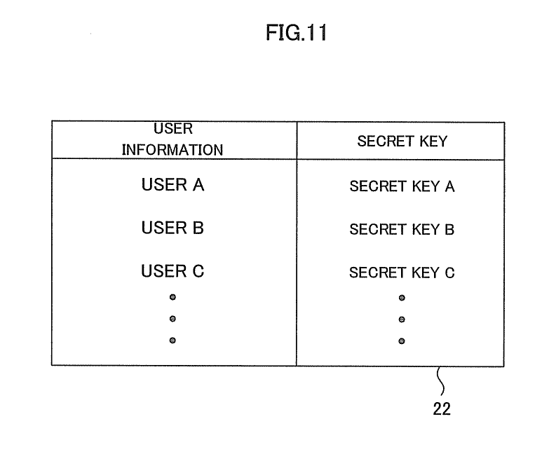

The private key database 22 is shown in FIG. 11. In the private key database 22, a private key allocated to each user is registered in association with user information for identifying the user corresponding to the private key. Therefore, for example, when the user information determined as coinciding by the determining unit 204 indicates the user A, the private key acquiring unit 216 acquires a private key A corresponding to the user A referring to the private key database 22. The private key database 22 is securely stored so that private keys do not leak to the outside.

The decrypting unit 206 decrypts the encrypted file acquired by the file acquiring unit 200 using the private key acquired by the private key acquiring unit 216. When the file is decrypted, if a proper private key corresponding to the encrypted public key is used, decryption processing is properly executed and a decrypted PDL file is obtained.

On the other hand, for example, if the user information is falsified and the user information determined as coinciding by the determining unit 204 and the user information of the user corresponding to the public key used for the encryption do not coincide with each other, the public key used for the encryption and the private key used for the decryption do not correspond to each other. Therefore, the file cannot be decrypted.

For example, the user A encrypts a file for the direct printing using a public key associated with the user A and stores the file in the external storage device 50. The user B illegally acquires the external storage device 50 and falsifies user information of an encrypted file into user information of the user B. If the user B can log in to the image forming apparatus 1 as the user B, user information for the login and the falsified user information added to the encrypted file coincide with each other in appearance. The private key acquiring unit 216 acquires a private key corresponding to the user B on the basis of the coinciding user information. The decrypting unit 206 attempts decryption of the encrypted file using the private key. However, the encrypted file is a file encrypted by the public key of the user A. Therefore, the encrypted file can be decrypted only by the private key of the user A and cannot be decrypted by the private key corresponding to the user B. Consequently, when the user information is falsified, the direct printing is not executed and information does not leak.

If the decrypting unit 206 cannot decrypt the encrypted file, the decrypting unit 206 may perform, on the display unit 14a of the operation panel 14 or the like, error display such as display to the effect that the decryption is unsuccessful.

When the decrypting unit 206 can properly decrypt the encrypted file, the image-formation-processing control unit 208 prints the file with the printer unit 18 using a PDL file obtained by decrypting the encrypted file.

The functional blocks of the image forming apparatus 1 according to this embodiment are explained above.

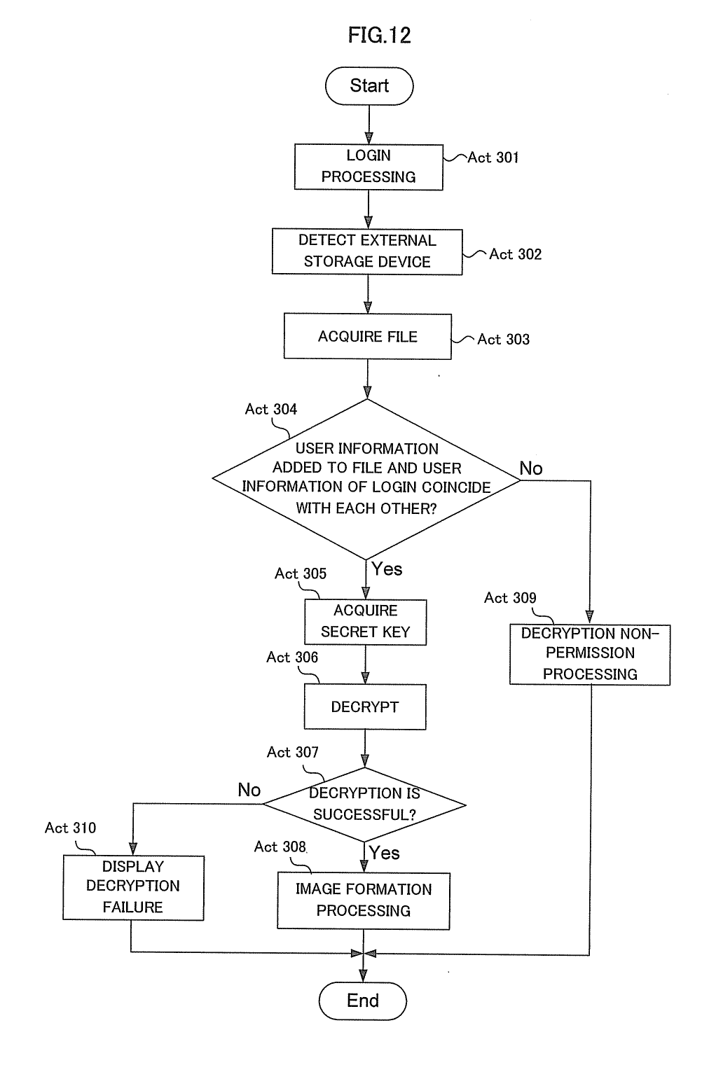

A flow of processing of the direct printing according to this embodiment is explained below. FIG. 12 is a flowchart for explaining a flow of processing of the direct printing of an encrypted file stored in the external storage device 50 in the image forming apparatus 1.

First, the card reading unit 12 reads an ID card of a user and the user authenticating unit 202 performs the login processing using read user information (Act 301). If the login processing is successful, the use of the image forming apparatus 1 is started.

Subsequently, when the external storage device 50 is connected to the image forming apparatus 1, the control unit 2 detects the external storage device 50 connected to the communication I/F 10 (Act 302).

The file acquiring unit 200 acquires, out of files stored in the detected external storage device 50, an encrypted file designated as a target file of the direct printing by operation input by the user on the operation panel 14 (Act 303).

The determining unit 204 compares user information added to the file acquired by the file acquiring unit 200 and the user information of the user logged in through the login processing and determines whether the pieces of user information coincide with each other (Act 304).

If the pieces of user information coincide with each other (Yes in Act 304), the private key acquiring unit 216 acquires, on the basis of the coinciding user information, a private key associated with the user information from the private key database 22 (Act 305).

On the other hand, if the determining unit 204 determines that the pieces of user information do not coincide with each other (No in Act 304), the determining unit 204 performs non-permission processing for not permitting decryption (Act 309). The non-permission processing is the same as that in the first embodiment.

The decrypting unit 206 performs the decryption processing for the encrypted file using the private key acquired by the private key acquiring unit 216 (Act 306).

If the decrypting unit 206 succeeds in the decryption (Yes in Act 307), the image-formation-processing control unit 208 performs image formation processing with the printer unit 18 using a decrypted PDL file (Act 308).

On the other hand, if the decrypting unit 206 fails in the decryption (No in Act 307), the decrypting unit 206 performs error display indicating, for example, the failure in the decryption on the display unit 14a of the operation panel 14 (Act 310).

The flow of the processing of the direct printing by the image forming apparatus 1 according to this embodiment is explained above.

With the image forming apparatus according to this embodiment, a file is encrypted by using the public key encryption system. Therefore, it is possible to perform more secure direct printing. In particular, even if user information or a digital signature added to an encrypted processing target file is falsified, the encrypted file is decrypted only by a private key of a user corresponding to a public key used for the encryption. Therefore, it is possible to surely prevent information leakage due to the direct printing.

As explained in detail above, according to the present invention, it is possible to provide an image forming apparatus that can surely prevent information leakage in the direct printing from an external storage device.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an interface configured to communicate with an external storage device;
a file acquiring unit configured to acquire a processing target file to be subjected to image formation processing from the external storage device via the interface;
a user-information acquiring unit configured to acquire user information for identifying a user who instructs execution of the image formation processing on the processing target file;
a determining unit configured to determine, if the processing target file is a file encrypted in a decryptable encryption system, whether user information for identifying a creator of the processing target file associated with the file and the user information acquired by the user-information acquiring unit coincide with each other; and
a decrypting unit configured to decrypt the processing target file if the determining unit determines that the pieces of user information coincide with each other.

2. The apparatus according to claim 1, further comprising:
a digital-signature acquiring unit configured to acquire a digital signature associated with the processing target file acquired by the file acquiring unit, the digital signature including a first irreversible conversion value generated by irreversible conversion on the basis of user information associated with the processing target file;
an irreversible-conversion-value generating unit configured to generate a second irreversible conversion value by performing the irreversible conversion on the basis of the user information associated with the processing target file acquired by the file acquiring unit; and
an irreversible-conversion-value comparing unit configured to compare the first irreversible conversion value included in the digital signature acquired by the digital-signature acquiring unit and the second irreversible conversion value generated by the irreversible-conversion-value generating unit and determine whether the first and second irreversible conversion values coincide with each other, wherein
the decrypting unit decrypts the processing target file if the irreversible-conversion-value comparing unit determines that the first and second irreversible conversion values coincide with each other.

3. The apparatus according to claim 2, wherein the irreversible conversion values are hash values.

4. The apparatus according to claim 1, wherein
the encrypted file is a file encrypted by a public key allocated to each the user,
the apparatus further comprises a private key acquiring unit configured to acquire, on the basis of the user information acquired by the user-information acquiring unit, a private key allocated to each user who can decrypt the file encrypted by the public key, and
the decrypting unit decrypts, if the determining unit determines that the pieces of user information coincide with each other, the processing target file using the private key acquired by the private key acquiring unit.

5. The apparatus according to claim 4, further comprising a private key database in which the private key allocated to each user is stored in association with the user information, wherein
the private key acquiring unit acquires the private key from the private key database.

6. The apparatus according to claim 4, further comprising an image-formation-processing control unit configured to control, if the decrypting unit succeeds in the decryption of the processing target file using the acquired private key, the image formation processing for the decrypted file.

7. The apparatus according to claim 1, further comprising a display unit configured to display information concerning processing in the apparatus, wherein
the determining unit causes, if the user information associated with the processing target file and the user information acquired by the user-information acquiring unit do not coincide with each other, the display unit to display to the effect that decryption of the processing target file is not performed.

8. An image formation processing method comprising:
acquiring a processing target file to be subjected to image formation processing from an external storage device;
acquiring user information for identifying a user who instructs execution of the image formation processing on the processing target file;
determining, if the processing target file is a file encrypted in a decryptable encryption system, whether user information for identifying a creator of the processing target file associated with the file and the acquired user information coincide with each other; and
decrypting the processing target file if it is determined that the pieces of user information coincide with each other.

9. The method according to claim 8, further comprising:
acquiring a digital signature associated with the acquired processing target file, the digital signature including a first irreversible conversion value generated by irreversible conversion on the basis of user information associated with the processing target file;
generating a second irreversible conversion value by performing the irreversible conversion on the basis of the user information associated with the acquired processing target file;
comparing the first irreversible conversion value included in the acquired digital signature and the generated second irreversible conversion value and determining whether the first and second irreversible conversion values coincide with each other; and
decrypting the processing target file if it is determined that the first and second irreversible conversion values coincide with each other.

10. The method according to claim 9, wherein the irreversible conversion values are hash values.

11. The method according to claim 8, wherein
the encrypted file is a file encrypted by a public key allocated to each the user, and
the method further comprises:
acquiring, on the basis of the acquired user information, a private key allocated to each user who can decrypt the file encrypted by the public key; and
decrypting, if it is determined that the user information associated with the processing target file and the acquired user information coincide with each other, the processing target file using the acquired private key.

12. The method according to claim 11, further comprising acquiring the private key from a private key database in which the private key allocated to each user is stored in association with the user information.

13. The method according to claim 11, further comprising performing, if the decryption of the processing target file performed by using the acquired private key is successful, the image formation processing for the decrypted file.

14. The method according to claim 8, further comprising performing, if the user information associated with the processing target file and the acquired user information do not coincide with each other, display to the effect that decryption of the processing target file is not performed.

15. A computer-readable recording medium having recorded thereon a computer program for causing a computer to execute processing for:
acquiring a processing target file to be subjected to image formation processing from an external storage device;
acquiring user information for identifying a user who instructs execution of the image formation processing on the processing target file;
determining, if the processing target file is a file encrypted in a decryptable encryption system, whether user information for identifying a creator of the processing target file associated with the file and the acquired user information coincide with each other; and
decrypting the processing target file if it is determined that the pieces of user information coincide with each other.

16. The recording medium according to claim 15, the computer program further causing the computer to execute processing for:
acquiring a digital signature associated with the acquired processing target file, the digital signature including a first irreversible conversion value generated by irreversible conversion on the basis of user information associated with the processing target file;
generating a second irreversible conversion value by performing the irreversible conversion on the basis of the user information associated with the acquired processing target file;
comparing the first irreversible conversion value included in the acquired digital signature and the generated second irreversible conversion value and determining whether the first and second irreversible conversion values coincide with each other; and
decrypting the processing target file if it is determined that the first and second irreversible conversion values coincide with each other.

17. The recording medium according to claim 16, the computer program further causing the computer to execute processing in which the irreversible conversion values are hash values.

18. The recording medium according to claim 15, wherein
the encrypted file is a file encrypted by a public key allocated to each the user, and
the computer program further causes the computer to execute processing for:
acquiring, on the basis of the acquired user information, a private key allocated to each user who can decrypt the file encrypted by the public key; and
decrypting, if it is determined that the user information associated with the processing target file and the acquired user information coincide with each other, the processing target file using the acquired private key.

19. The recording medium according to claim 18, the computer program further causing the computer to execute processing for acquiring the private key from a private key database in which the private key allocated to each user is stored in association with the user information.

20. The recording medium according to claim 18, the computer program further causing the computer to execute processing for performing, if the decryption of the processing target file performed by using the acquired private key is successful, the image formation processing for the decrypted file.
